(19) United States
(12) Patent Application Publication
(10) Pub. No.: US 2017/0075566 A1
(43) Pub. Date: Mar. 16, 2017

(54) MOBILE TERMINAL AND CONTROLLING METHOD THEREOF

(71) Applicant: LG ELECTRONICS INC., Seoul (KR)

(72) Inventors: Yonghahk PARK, Seoul (KR); Joohyung LEE, Seoul (KR); Yeunjin KONG, Seoul (KR); Saeik CHO, Seoul (KR); Hyunghoon OH, Seoul (KR)

(73) Assignee: LG ELECTRONICS INC., Seoul (KR)

(21) Appl. No.: 15/122,107

(22) PCT Filed: Feb. 12, 2015
(86) PCT No.: PCT/KR2015/001434

§ 371 Date: Aug. 26, 2016

(30) Foreign Application Priority Data
Feb. 28, 2014 (KR) 10-2014-0023935

(51) Int. Cl. G06F 3/0488; G06F 3/023

(52) U.S. Cl. CPC G06F 3/04886; G06F 3/0237; G06F 2203/04803

(57) ABSTRACT

Disclosed are a mobile terminal and controlling method thereof, by which a virtual keypad with high accuracy can be provided to the mobile terminal. The present invention may include a touchscreen displaying a keypad including a plurality of key buttons and a controller, if a touch input to the keypad is detected, determining coordinates of the detected touch input, the controller determining for the determined coordinates the key button having a highest probability among a plurality of the key button currently displayed using a previously cumulated dot history, the controller processing an input to the key button having the highest probability.

### TECHNICAL FIELD

The present invention relates to a mobile terminal, and more particularly, to a mobile terminal and controlling method thereof. Although the present invention is suitable for a wide scope of applications, it is particularly suitable for providing a virtual keypad with high accuracy.

### BACKGROUND ART

Generally, terminals can be classified into mobile/portable terminals and stationary terminals. The mobile terminals can be further classified into handheld terminals and vehicle mount terminals according to possibility of user's direct portability.

As functions of the terminal are getting diversified, the terminal tends to be implemented as a multimedia player provided with composite functions such as photographing of photos or videos, playback of music or video files, game play, broadcast reception and the like for example.

To support and increase the terminal functions, it may be able to consider the improvement of structural parts and/or software parts of the terminal.

As a touchscreen is normally installed on a mobile terminal, such a virtual keypad as an IME (input method editor) keyboard or the like is generally applied to input key buttons.

However, when a key button is selected through a touch input from a virtual keypad, there is a difference between a location of a key button desired to be selected by a user from a keypad and a recognized region actually pressed by the user, typing errors or wrong selections are frequently made. Therefore, the demand for a mobile terminal capable of providing a virtual keypad with high recognition accuracy is increasingly rising.

### DISCLOSURE

### Technical Problem

Accordingly, the present invention is directed to a mobile terminal and controlling method thereof that substantially obviate one or more of the problems due to limitations and disadvantages of the related art.

One object of the present invention is to provide a mobile terminal and controlling method thereof, by which a recognition rate of a virtual keypad can be raised.

Particularly, one object of the present invention is to provide a mobile terminal and controlling method thereof, by which a recognition rate of a virtual keypad can be raised in a manner of learning a user's key button touch pattern.

Technical tasks obtainable from the present invention are non-limited by the above-mentioned technical tasks. And, other unmentioned technical tasks can be clearly understood from the following description by those having ordinary skill in the technical field to which the present invention pertains.

### Technical Solution

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a mobile terminal according to one embodiment of the present invention includes a touchscreen displaying a keypad including a plurality of key buttons and a controller, if a touch input to the keypad is detected, determining coordinates of the detected touch input, the controller determining for the determined coordinates the key button having a highest probability among a plurality of the key button currently displayed using a previously cumulated dot history, the controller processing an input to the key button having the highest probability.

To further achieve these and other advantages and in accordance with the purpose of the present invention, as embodied and broadly described, a method of controlling a mobile terminal according to another embodiment of the present invention includes the steps of displaying a keypad including a plurality of key buttons on a touchscreen, detecting whether a touch input is applied to the keypad, if the touch input is detected, determining coordinates of the detected touch input, determining for the determined coordinates the key button having a highest probability among a plurality of the key button currently displayed using a previously cumulated dot history, and processing an input to the key button having the highest probability.

To further achieve these and other advantages and in accordance with the purpose of the present invention, as embodied and broadly described, a method of controlling a mobile terminal according to further embodiment of the present invention includes the steps of displaying a plurality of virtual graphic user interface (GUI) items available for activation on a touchscreen, determining a touch point of a touch input for activating a prescribed one of a plurality of the virtual GUI items, determining a distance parameter for calculating a probability between the touch point and each of a plurality of the virtual GUI items through probability & statistics analysis on the touch input, calculating the probability between the touch point and each of a plurality of the virtual GUI items using the parameter in order to determine a prescribed virtual GUI item to activate among a plurality of the virtual GUI items, and generating a signal indicating activation of the determined prescribed virtual GUI item.

It is to be understood that both the foregoing general description and the following detailed description are exemplary and explanatory and are intended to provide further explanation of the invention as claimed.

### Advantageous Effects

Accordingly, the present invention provides the following effects and/or features.

First of all, accuracy of a key button input through a virtual keypad can be enhanced.

Particularly, as a user's key button touch pattern is cumulatively learned, the accuracy can be further enhanced in proportion to a frequency of use.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention. The above and other aspects, features, and advantages of the present invention will become more apparent upon consideration of the following description of preferred embodiments, taken in conjunction with the accompanying drawing figures.

In the drawings:

FIG. 1 is a block diagram to describe a mobile terminal related to the present invention;

FIG. 2a and FIG. 2b are diagrams for the concept of a mobile terminal related to the present invention in different views;

FIG. 3 is a diagram for one example of a distribution of dots per user on a virtual keypad;

FIG. 4 is a diagram for one example of a recognition region distribution of a general virtual keypad;

FIG. 5 is a flowchart for one example of a method of determining a key button using a probability model according to one embodiment of the present invention;

FIG. 6 is a diagram for one example of a dot history modeled through 2D Gaussian distribution according to one embodiment of the present invention;

FIG. 7 is a diagram for one example of a clustered pattern in accordance with a confident region, in which the dots shown in FIG. 6 are configured to correspond to a key button displayed region, according to one embodiment of the present invention;

FIG. 8 is a diagram for one example of a possible region configured pattern according to one embodiment of the present invention;

FIG. 9 is a diagram for one example of a pattern of modified probability distribution on a space bar according to one embodiment of the present invention; and

FIG. 10 is a diagram for one example of a pattern of displaying a recognition range per key button depending on a probability module according to one embodiment of the present invention.

### MODE FOR INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

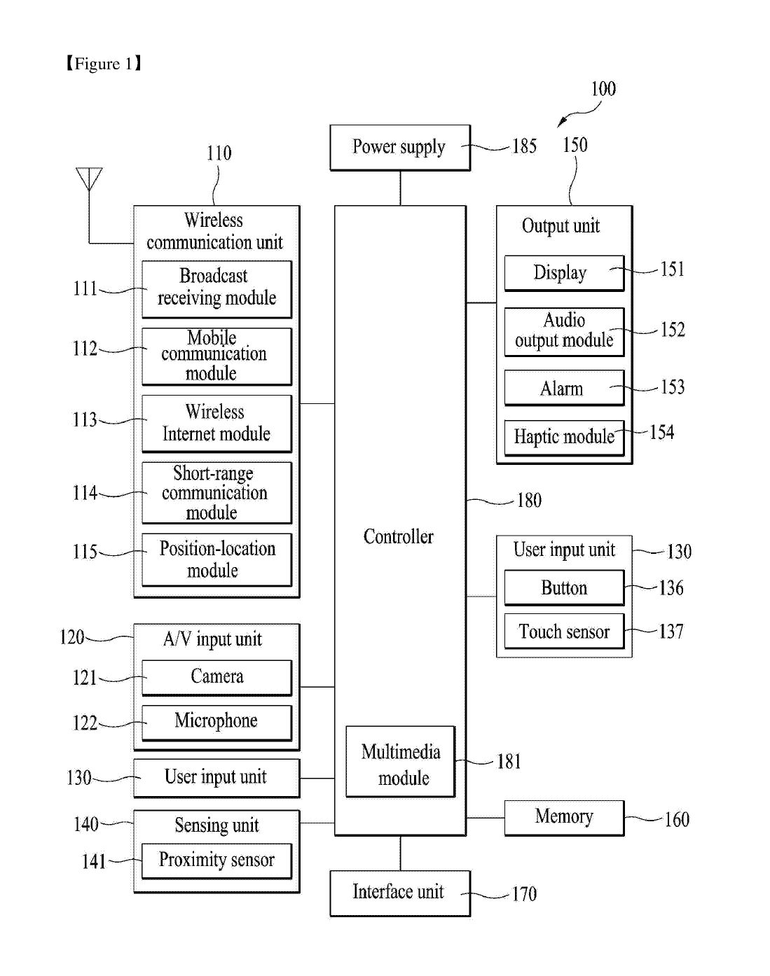

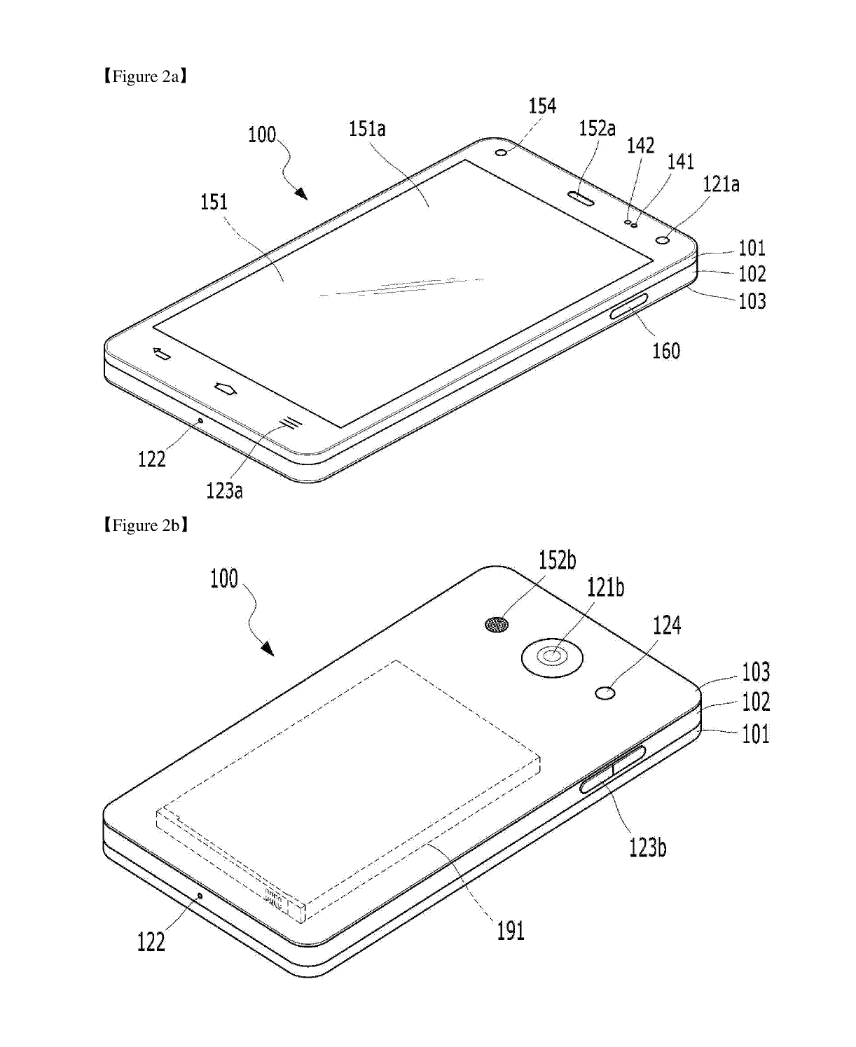

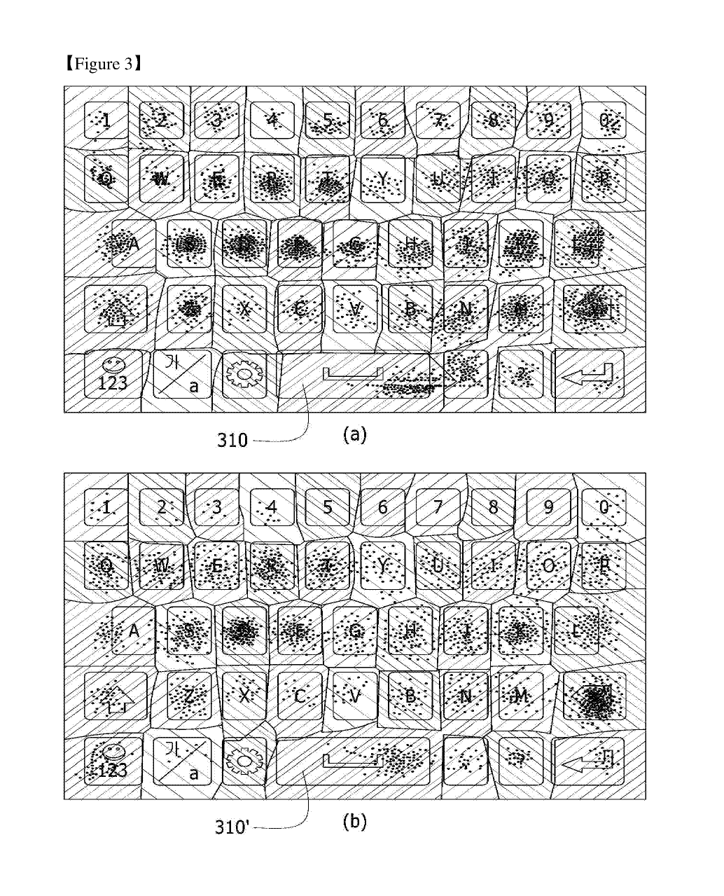

Reference is now made to FIGS. 1-2b, where FIG. 1 is a block diagram of a mobile terminal in accordance with the present disclosure, and FIGS. 2a and 2b are conceptual views of one example of the mobile terminal, viewed from different directions.

According to the present invention, various functions are provided through linked operations between a mobile terminal and a wearable device. Therefore, a configuration of a watch type wearable device is described as one example of a wearable device to which the present invention is applicable.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Referring still to FIG. 1, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast managing entity may be implemented using a server or system which generates and transmits a broadcast signal and/or broadcast associated information, or a server which receives a pre-generated broadcast signal and/or broadcast associated information, and sends such items to the mobile terminal. The broadcast signal may be implemented using any of a TV broadcast signal, a radio broadcast signal, a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in this case, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

In general, a 3D stereoscopic image may include a left image (e.g., a left eye image) and a right image (e.g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis.

Also, as for a 3D thumbnail image, a left image thumbnail and a right image thumbnail can be generated from a left image and a right image of an original image frame, respectively, and then combined to generate a single 3D thumbnail image. In general, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense.

A left image and a right image required for implementing a 3D stereoscopic image may be displayed on the stereoscopic display unit using a stereoscopic processing unit. The stereoscopic processing unit can receive the 3D image and extract the left image and the right image, or can receive the 2D image and change it into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 2a and 2b, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

FIGS. 2a and 2b depict certain components as arranged on the mobile terminal. However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 2a illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 2b, a flash 124 is shown adjacent to the second camera 121b. When an image of a subject is captured with the camera 121b, the flash 124 may illuminate the subject.

As shown in FIG. 2a, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

<Improvement of Accuracy of Touch to Virtual Keypad>

Generally, since each key button is generally disposed and displayed on a virtual keypad (OME) displayed on a touchscreen in a manner that a position of the key button is determined in advance, it beings an effect of selecting a key button displayed at a touch input recognized point. Hence, as a key button actually intended by a user and a key button recognized by IME in mapping are different from each other due to key disposition properties of a keypad, a space difference in glass thickness between a touch panel and a display, an angle difference between human eyes and the like, mistyping/malfunction occurs frequently. Moreover, even if the same mobile terminal having the same IME applied thereto is used, each user has a different input dot location at each key button. The same user does not always touches the same location of a specific key button. Instead, dots are distributed on the corresponding key button or around a specific point on the corresponding key button. This is described in detail with reference to FIG. 3 as follows.

FIG. 3 is a diagram for one example of a distribution of dots per user on a virtual keypad.

Referring to FIG. 3, points touched on a virtual keypad by two different users are displayed as dots in a manner of being cumulated. Although a virtual keypad of a same type is used, when a user corresponding to FIG. 3 (a) touches a space bar 310, it can be observed that dots are concentrated on a right bottom end. When a user corresponding to FIG. 3 (b) touches a space bar 310′, it can be also observed that dots are concentrated on a right middle end at the left hand of the right bottom end shown in FIG. 3 (a). In this case, since a cluster concentrated on the space bar 310 is considerably adjacent to a right key button next to the space bar 310, when the user corresponding to FIG. 3 (a) intends the space bar, it is highly probable that the right key button may be recognized. Hence, it is apparent that a typing error (or a mis-typing) is frequently expected.

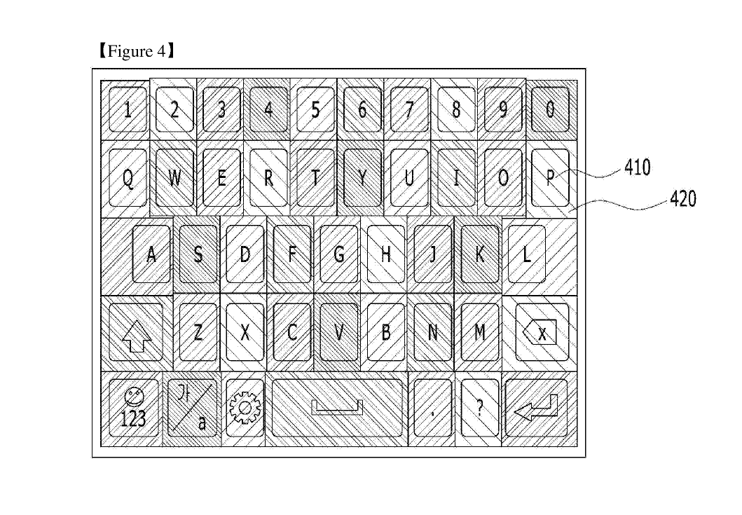

A general IME virtual keypad model is described in detail with reference to FIG. 4 as follows. First of all, according to an existing IME model, a rectangular touch recognition region is provided to each key button. If coordinates of a left top of the recognition region and coordinates of a right bottom corner of the recognition region are provided only, it is able to know that a dot touched by a user belongs to a recognition region of a specific key button through a simple formula. In particular, the rectangular touch recognition region can be configured in a manner of including a key button drawn region 410 and a peripheral region 420 adjacent to the key button drawn region 410. In this case, the peripheral region 420 may be set to have an intermediate distance from an adjacent key button in general. Meanwhile, the rectangular recognitions may overlap with each other depending on a disposition of a keypad or a region recognition. In this case, it can be recognized that a key is preferentially assigned to the recognition region drawn later. Namely, it can be recognized that a key button corresponding to the recognition region drawn later is selected.

As mentioned in the foregoing description, according to the related art method of enabling coordinates a recognition region to correspond to coordinates of a dot, it is difficult for a dot according to user's habit or environment to be mapped to a key button actually desired by a user.

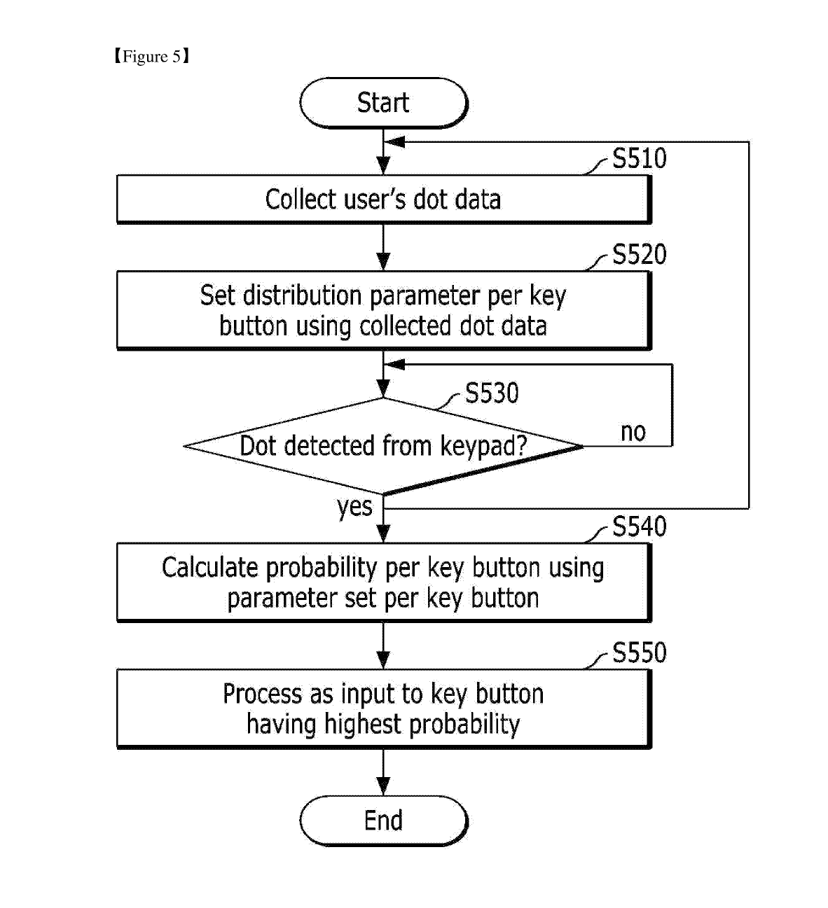

Therefore, according to one embodiment of the present invention, by introducing a per-key button probability model that employs cumulative data of a dot from which a user's touch input is recognized, it is proposed to recognize a key button having a highest probability of a user's intention at a dot. This is described in detail with reference to FIG. 5 as follows.

FIG. 5 is a flowchart for one example of a method of determining a key button using a probability model according to one embodiment of the present invention.

Referring to FIG. 5, the controller 180 collects data (history) of a dot each time a user applies a touch input using a virtual keypad [S510]. In this case, the dot can be saved as coordinates. The controller 180 sets a per-key button distribution parameter with the collected dot data [S520]. If a new touch input is detected from the virtual keypad [S530], the controller 180 can calculate a probability of each key button using a parameter of a key button adjacent to the corresponding dot or a parameter set for each of all key buttons [S540]. As a result, the controller 180 maps a detected new dot to a key button having a highest probability and is able to control an operation matching the corresponding key button to be performed [S550].

In the following description, a per-key button distribution parameter setup using a collected dot data and a method of calculating a per-key button probability for a new dot using the per-key button distribution parameter setup are explained in detail as follows. Since a detailed probability formula can be implemented through various modifications made by those skilled in the art, the following description shall be made in the principle-oriented manner.

First of all, as a basis of the aforementioned probability model, it is able to use 2D Gaussian distribution most natural and appropriate for the modelling of data distributed around a center of a cumulated dot group (i.e., cluster). In particular, when a touch input is applied to random coordinates, a probability that the corresponding touch input is an input to a specific key button is calculated. And, it is able to use a prior probability of the specific key button together with the calculated probability.

For instance, it is assumed that a probability that an input to an ith key button is applied to random touch coordinates x_j is P(x_j|C_i). And, it is assumed that a prior probability that the ith key button is pressed at this point is P(C_i). If so, when the touch input to the random coordinates x_j is applied, a probability P(C_i|x_j) that the corresponding touch input is the input to the ith key button can be represented as {P(x_j|C_i)P(C_i)}/{/P(x_j)}∝P(x_j|C_i)P(C_i).

The prior probability can be utilized if an input probability can be found by Automatic Word Fragment Completion mentioned in the following description. If there is no prediction for this, it can be reset uniformly.

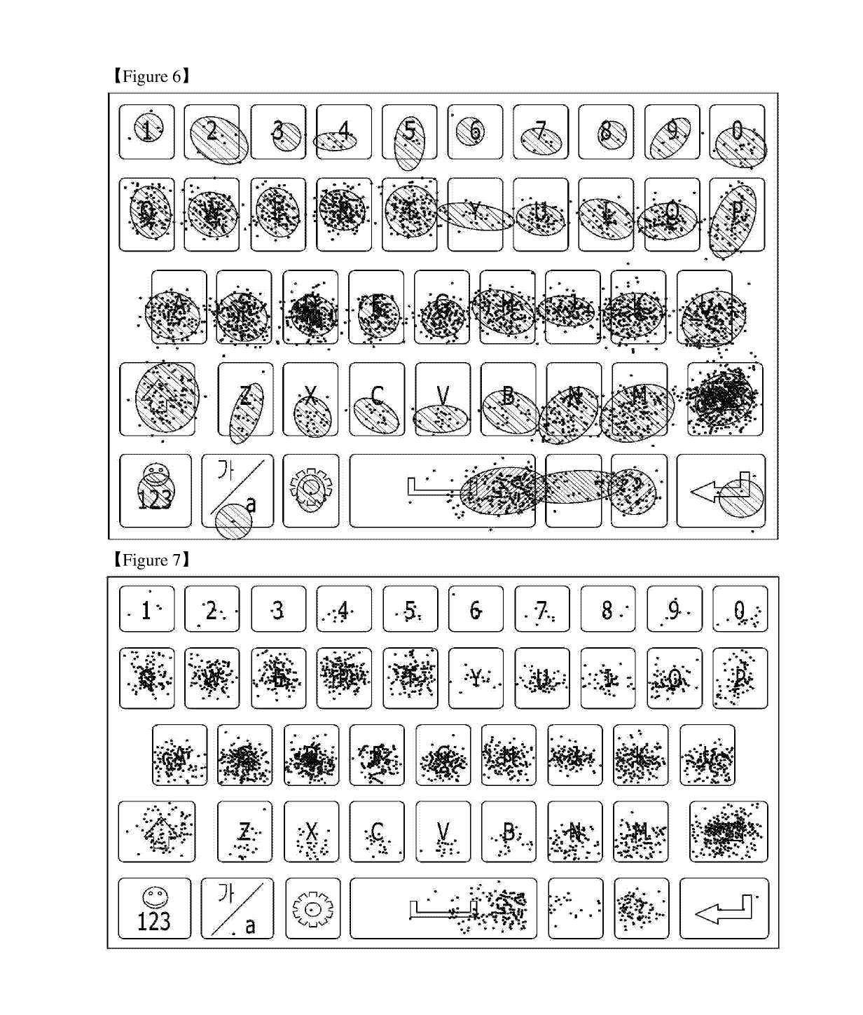

FIG. 6 shows one example of a dot history modeled through the above-described 2D Gaussian distribution.

In FIG. 6, as a most basic classifier for classifying that dot coordinates belong to a prescribed category (i.e., a key button) in case of a presence of data of Gaussian probability distribution, it is able to use a Bayes Gaussian classifier in order to map the dot coordinates to a key button having a highest posterior probability.

In order to raise the accuracy of a key button mapping through a Bayes Gaussian classifier, a parameter learning is required. As one example of this learning scheme, it is able to apply a machine learning scheme to the present invention. Generally, in case of a data set having a correct index exist therein, it is able to easily obtain a parameter of each cluster through a supervised learning. Yet, in case of IME input, there exist many typing errors. And, it is difficult to record a user-intended input together with real touch data. Hence, according to the present invention, it is proposed to perform a parameter learning for a mechanical learning with K-Means Clustering that is a representative unsupervised learning. The K-Means Clustering is one of vector quantization methods. The K-Means Clustering is widely used for a cluster analysis of a data mining such as a signal processing field. And, the K-Means Clustering is generally used to divide n object groups into k clusters. If the present method is applied to the clustering of dots to a key button, the following process is performed. First of all, all dots are assigned to key buttons in a random way. Secondly, by calculating an average and covariance for each cluster, an expectation step and an assigning step are repeated. Thirdly, if there is no difference in cluster assignment in comparison with a previous repeat order, the repetition can be ended.

Yet, if the basic K-Means clustering is used intactly without modification, it may have a difficulty in calculating a probability in association with a real key button disposition. In particular, when the K-Means Clustering is applied to an IME keyboard, if the above-mentioned basic K-Means Clustering algorithm is applied as it is, it may cause a problem that a classification result may not converge well or a problem that a cluster moves to an undesired place (i.e., a location unrelated to a key button). Algorithm added conditions to solve these problems and methods for improving algorithm performance using additional informations are proposed as follows.

1) Confident Region

By configuring a confident region for each key button, a dot in the confident region is regarded as a touch for intending the corresponding button. And, dots located within the confident region can be fixedly mapped to a cluster matching the corresponding key button. Thus, each touch input cluster is located around each corresponding key button. One example of the confident region and touch coordinates classified as the corresponding key buttons are shown in FIG. 7. FIG. 7 shows one example of a clustered pattern in accordance with a confident region, in which the dots shown in FIG. 6 are configured to correspond to a key button displayed region, according to one embodiment of the present invention.

2) Possible Region

By configuring a mapping possible region for each key, a dot located within the possible region can be clustered into a corresponding key button. Thus, even if the number of samples corresponding to the respective key buttons is insufficient, a cluster can be located nearby the corresponding key button without moving abnormally. FIG. 8 shows one example of configuring a possible region. Referring to FIG. 8, a possible region is configured as a biggest rectangular region without infringing a confident region of another key button.

3) Treatment of Special Key Button

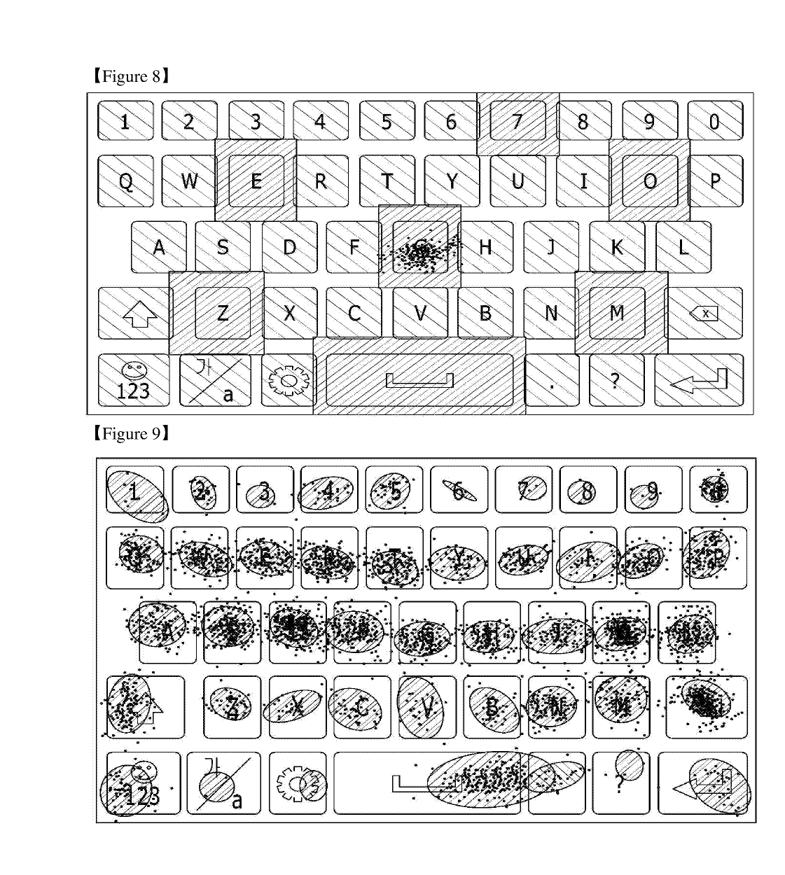

Despite differences in language or type of a keypad, regions of several key buttons may have shapes and sizes different from those of the rest of key buttons in general. Hence, special treatments may be required. For instance, in a general keypad layout of QWERTY type, since a biggest region is assigned to a space bar key button, it causes a problem that a recognition region of a neighbor key is vulnerable to infringement. Hence, in calculating a prior probability for a space bar, it is ale to raise a probability of mapping to the space bar unlike other key buttons. Through this treatment, a probability distribution for the space bar shown in FIG. 6 can be modified into that shown in FIG. 9.

In the following, described is a probability calculation in case of modifying K-Means Clustering Algorithm through the above-mentioned performance improving method.

First of all, in an initialization step prior to a full-scale probability calculation, a variable for each confident region and an adjusted prior probability value are set. Secondly, in an assigning step, in case of taking consideration of the confident region, it is determined whether a dot is included in a confident region of a specific key button. Only if the dot is not included in the confident region of the specific key button, a posterior probability can be modified to be calculated.

Of course, if the algorithm is modified as mentioned in the above description, an average and covariance matrix of clusters calculated by the above-descried process are provided to the Bayes Gaussian classifier.

4) Prior Probability

In the following, the aforementioned prior probability is described in detail.

As mentioned in the foregoing description, if a probability that a prescribed key will be pressed is obtained in advance, a prior probability model is to use a parameter to utilize the obtained probability. A prior probability parameter is an external value unrelated to Gaussian distributions of a cluster. And, the prior probability parameter can be utilized if an input probability of a keyboard can be found with word expectation or the like. In case of using an n-gram model for the word expectation, IME algorithm can find a current key button input probability through (n ? 1) previous input values, which becomes a prior probability. Yet, in case that an existing sample does not exist (e.g., a case that a word related to a currently inputted key button does not exist, etc.) in the word expectation, it may cause a problem that a prior probability becomes 0. In this case, since a problem that the corresponding key button is not inputted is caused, it may be able to use a smoothing scheme. For instance, if a prior probability is set to P_raw (C_i) and an initialized uniform prior probability is set to {P_uniform (C_i)=1/M, ∀i}, it is able to obtain a smoothed prior probability as follows.

P(C_i)=(1−Smoothing factor)P_raw(C_i)+(Smoothing factor)P_uniform(C_i)

In this case, a smoothing factor may be given by a user or a manufacturer and has a value of 0 to 1. If there is no previously calculable P_raw, it may be able to use P(C_i)=P_uniform (C_i).

5) Backspace Feedback

If a backspace key is selected, it is highly probable that a mapping of a previous dot is an error (i.e., a mistyping in aspect of a user). Hence, in order to lower a probability that the same mapping reoccurs, if a probability corresponding to a key button mapped to a corresponding dot is lowered, it is able to reduce the mapping error that may reoccur. Yet, if the backspace is consecutively inputted over twice, it is not clear whether a user intends to erase an input to a prescribed key button. Hence, it may be able to avoid lowering the probability due to the backspace key. In particular, in case of Korean, if the backspace key is pressed over twice, a whole word may be erased. Hence, it frequently happens that it is unable to know an input intended to be erased by a user. Of course, a probability lowered correction rate may be set or changed by a user or a manufacturer.

Meanwhile, besides the aforementioned probability improving method, if there is no initially collected data like a case that a user uses a mobile terminal initially, a parameter for calculating a probability of each key button may be set to a statistically collected default value. In this case, the default value may be configured with a plurality of sets depending on a user's habit (e.g., right-handed, left-handed, both-handed, etc.), a hand size, a language (e.g., Korean, English, etc.) or the like.

Moreover, a user's touch property (e.g., top/bottom-oriented, right/left-oriented, etc.) learned on the basis of a cumulated dot history through a use of a single keypad can be applied to a case of using a key pad of a different type (e.g., a different language, a different layout, etc.).

Besides, according to one embodiment of the present invention, the controller 180 identifies a user using a cumulated dot history and is able to provide a corresponding function. In a user identifying method, the controller 180 may determine similarity by comparing a current keypad input pattern to a previous pattern. And, the controller 180 can determine that a user is changed if a frequency of selecting a backspace button rises. Using this, if a touch input of a pattern different from that of a previous history is consecutively applied, the controller 180 may not add the corresponding touch input to a dot history to avoid using the corresponding touch input for a learning. In this case, it is able to prevent a dot learning error due to a temporary use of another user.

Moreover, the present function may be applicable in aspect of security. For instance, if it is determined that a user is changed, the controller 180 takes a photo of a current user's face and is then able to prevent personal information leakage by restricting an authority of an access to personal information or leaving a use record. For another instance, as a new method of unlocking a lock screen, the lock screen can be unlocked in a manner of inputting a specific word to a user virtual keypad displayed on the lock screen, comparing a dot pattern to a cumulated dot pattern, and then unlocking the lock screen in case of a presence of similarity equal to or greater than a predetermined level.

On the other hand, in case that patterns for a plurality of users are recorded and compared, the present function is usable for a customizing per user. For instance, if a current input pattern matches a different user's keyboard input pattern previously saved, a user interface customized for the corresponding user and the like can be provided. When a multi-user mode (e.g., admin mode, guest mode, etc.) is provided, if the guest mode is activated, it is able to provide a keypad having each probability parameter reset to an initial state instead of a keypad learned at user account.

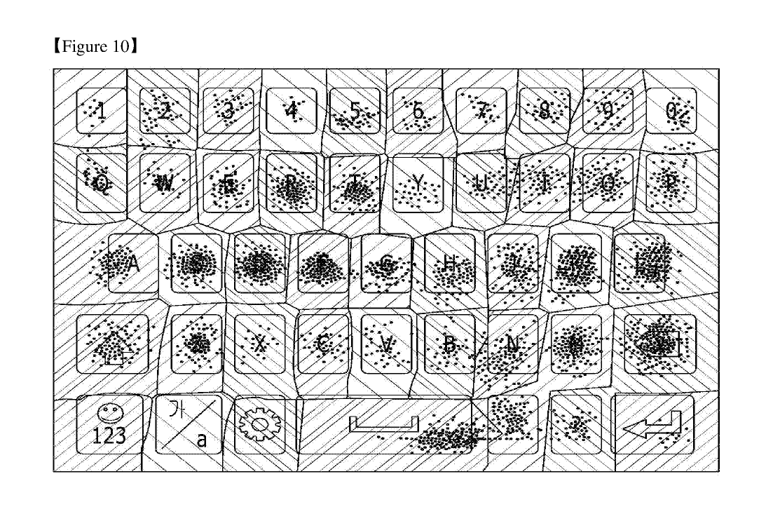

Moreover, according to one embodiment of the present invention, the controller 180 can feed back a dot history cumulated status or a dot history corrected status to a user through the output unit 150. For instance, each time N dots are cumulated, the controller 180 can control the audio output unit 152 to output a message ‘Your touch pattern has been learned until now using M inputs.’, or the like. For another instance, when a key button is touched, if a default sound is outputted, although real dot coordinates are the location at which a different key button is displayed, if the different key button is recognized as a result of the probability according to a user's pattern, the controller 180 controls a sound different from the default sound to be outputted, thereby informing a user that an auto correction is performed. For further instance, a region having a highest probability in each key is displayed on a virtual keypad, as shown in FIG. 10, through a visual effect. Through this, a user is able to understand and correct a touch pattern of the user and is able to confirm a range capable of actually recognizing each key button. Besides, the controller 180 may display a typing error rate per key button through a dot and an actual recognition history and a different adjacent key button frequently pressed in the course of selecting a specific key button.

Accordingly, through a key button recognition using the probability model mentioned in the foregoing description, a recognition region of each key button can be substantially adjusted in accordance with a user's dot history. As a probability of a dot is calculated in consideration of language properties, user's habits and the like, a key button having a highest probability of user's intention can be mapped to the corresponding dot. Hence, if a range of a key button displayed on a touchscreen fails to match an actual dot or a region of another key is infringed, a user intended key button can be automatically inputted.

### INDUSTRIAL APPLICABILITY

It will be appreciated by those skilled in the art that the present invention can be specified into other form(s) without departing from the spirit or scope of the inventions.

The above-described methods can be implemented in a program recorded medium as computer-readable codes. The computer-readable media may include all kinds of recording devices in which data readable by a computer system are stored. The computer-readable media may include ROM, RAM, CD-ROM, magnetic tapes, floppy discs, optical data storage devices, and the like for example and also include carrier-wave type implementations (e.g., transmission via Internet). Further, the computer may include the controller 180 of the terminal.

It will be appreciated by those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A method of controlling a mobile terminal, comprising the steps of:
displaying a keypad including a plurality of key buttons on a touchscreen;
detecting whether a touch input is applied to the keypad;
if the touch input is detected, determining coordinates of the detected touch input;
determining for the determined coordinates a key button having a highest probability among the plurality of key buttons currently displayed using a previously cumulated dot history; and
processing an input to the key button having the highest probability.

2. The method of claim 1, the step of determining the key button having the highest probability, comprising the step of finding a probability of each of the key buttons using Gaussian distribution parameter set for each of the key buttons and a prior probability.

3. The method of claim 2, wherein the Gaussian distribution parameter set for each of the key buttons is determined in accordance with a result of a mapping to a cluster in which a plurality of dots included in the cumulated dot history correspond to each of the key buttons.

4. The method of claim 3, wherein the mapping to the cluster is performed in a manner that at least one dot located within a first region for a specific key button among a plurality of the dots is mapped to the cluster corresponding to the specific key button and that at least one dot located outside a second region for the specific key button among a plurality of the dots is not mapped to the cluster corresponding to the specific key button.

5. The method of claim 4, wherein the first region corresponds to a region having the specific key button displayed on the touchscreen and wherein the second region is configured not to infringe a region having the key button other than the specific key button displayed on the touchscreen.

6. The method of claim 2, wherein the prior probability corresponds to a size of each of the key buttons displayed on the touchscreen.

7. The method of claim 2, further comprising the step of if the key button corresponding to a backspace is inputted after the touch input, lowering a probability for the key button processed in accordance with the touch input.

8. A mobile terminal comprising:
a touchscreen configured to display a keypad including a plurality of key buttons; and
a controller configured to, if a touch input to the keypad is detected, determining coordinates of the detected touch input, determine for the determined coordinates a key button having a highest probability among the plurality of key buttons currently displayed using a previously cumulated dot history, and process an input to the key button having the highest probability.

9. The mobile terminal of claim 8, wherein the controller finds a probability of each of the key buttons using Gaussian distribution parameter set for each of the key buttons and a prior probability.

10. The mobile terminal of claim 9, wherein the Gaussian distribution parameter set for each of the key buttons is determined in accordance with a result of a mapping to a cluster in which a plurality of dots included in the cumulated dot history correspond to each of the key buttons.

11. The mobile terminal of claim 10, wherein the mapping to the cluster is performed in a manner that at least one dot located within a first region for a specific key button among a plurality of the dots is mapped to the cluster corresponding to the specific key button and that at least one dot located outside a second region for the specific key button among a plurality of the dots is not mapped to the cluster corresponding to the specific key button.

12. The mobile terminal of claim 11, wherein the first region corresponds to a region having the specific key button displayed on the touchscreen and wherein the second region is configured not to infringe a region having the key button other than the specific key button displayed on the touchscreen.

13. The mobile terminal of claim 9, wherein the prior probability corresponds to a size of each of the key buttons displayed on the touchscreen.

14. The method of claim 9, wherein if the key button corresponding to a backspace is inputted after the touch input, the controller lowers a probability for the key button processed in accordance with the touch input.

15. A method of controlling a mobile terminal, comprising the steps of:
displaying a plurality of virtual graphic user interface (GUI) items available for activation on a touchscreen;
determining a touch point of a touch input for activating a prescribed one of a plurality of the virtual GUI items;
determining a distance parameter for calculating a probability between the touch point and each of a plurality of the virtual GUI items through probability & statistics analysis on the touch input;
calculating the probability between the touch point and each of a plurality of the virtual GUI items using the parameter in order to determine a prescribed virtual GUI item to activate among a plurality of the virtual GUI items; and
generating a signal indicating activation of the determined prescribed virtual GUI item.
